(19) United States
(12) Patent Application Publication
(10) Pub. No.: US 2018/0205696 A1
(43) Pub. Date: Jul. 19, 2018

(54) METHOD FOR NETWORK VOICE COMMUNICATION

(71) Applicant: FREEFLY881 COMMUNICATIONS INC., Beijing (CN)

(72) Inventors: Edward ZHENG, Beijing (CN); Raymond KWAN, Beijing (CN)

(21) Appl. No.: 15/871,883

(22) Filed: Jan. 15, 2018

(30) Foreign Application Priority Data
Jan. 17, 2017 (CN) 201710031922.2

(51) Int. Cl. H04L 29/12; H04M 3/42; H04M 3/53; H04M 3/533

(52) U.S. Cl. CPC H04L 61/2007; H04L 61/1594; H04M 3/42374; H04L 61/2092; H04M 3/53366; H04L 61/605; H04M 3/5307

(57) ABSTRACT

The disclosure relates to a method for network voice communication, the method comprising: a user in the global world applying for and obtaining a network voice communication number through a network voice communication client, the network voice communication number entirely consisting of multiple digits; using the network voice communication number as the network address of network voice communication of the user; performing voice communication between users that have obtained network voice communication numbers through the Internet; wherein there is no need for the users to go through an invitation, acceptance or authentication process with each other during the network voice communication. The present disclosure utilizes the sharing property of the Internet to extend the scope of free call applications to support mobile phones, tablets, IP landline phones (Internet phones) and Internet mobile phones, and realizes a free call function.

### CROSS-REFERENCE OF THE RELATED APPLICATIONS

The present application is based upon and claims priority of Chinese Patent Application No. 201710031922.2, filed before Chinese Patent Office on Jan. 17, 2017 and entitled “Method for Network Voice Communication,” the entire contents of which is incorporated herein by reference.

### TECHNICAL FIELD

The present disclosure relates to the field of network communication technologies, and in particular, to a method for network voice communication.

### BACKGROUND

With the development of Wi-Fi and mobile Internet, the coverage of the internet is getting wider and wider, and the sharing property of the Internet brings great convenience to people. In the field of communication, free calls have been generated by utilizing the sharing property of the Internet. For example, Skype network call have achieved the global free, but only when users have dialed up on the computer terminal. Although domestic and abroad mobile phones and landline phones may be called at low rates, there are still an invitation and acceptance processes required before the two parties begin free call, thereby it causes the certain inconvenience.

### SUMMARY

In order to solve the abovementioned problem, an object of the present disclosure is to provide a method for providing a free global phonebook and free voice communication to users through Wi-Fi and the Internet so as to solve the problem that the current global voice communication is expensive and inconvenient.

In order to achieve the abovementioned object, the present disclosure provides a method for network voice communication, comprising: a user in the global world applies for and obtains a network voice communication number through a network voice communication client, the network voice communication number entirely consists of multiple digits; using the network voice communication number as the network address of network voice communication of the user; performing voice communication between users that have obtained the network voice communication numbers through the Internet, wherein there is no need for the users to certify each other during the network voice communication.

In the method for network voice communication without the need for authentication, disclosed in the present disclosure, the user applying for and obtaining a network voice communication number comprises: after the user has applied, using his or her own mobile phone number to create a network voice communication number, wherein the network voice communication number consists of three fixed digits, a country code and a mobile phone number arranged in sequence, and therein the three fixed digits are 881.

In the method for network voice communication without the need for authentication, disclosed in the present disclosure, the user applying for and obtaining a network voice communication number comprises: after the user has applied, selecting one number from the multiple pushed network voice communication numbers as his or her own network voice communication number, wherein the network voice communication number consists of three fixed digits and ten arbitrary digits arranged in sequence, and therein the three fixed digits are 882.

In the method for network voice communication without the need for authentication, disclosed in the present disclosure, the process of the user applying for and obtaining a network voice communication number further comprises: the user registers to generate a user information, the user information comprises a name, a network voice communication number and an e-mail; and the generated user information form a phonebook and present on a user terminal; and the user can query from the phonebook by a keyword or keywords on the user terminal.

In the method for network voice communication without the need for authentication, disclosed in the present disclosure, the user information further comprises one or more of mobile phone number, country, network link, website address, profession and personal description.

In the method for network voice communication without the need for authentication, disclosed in the present disclosure, the personal description consists of one or more keywords.

In the method for network voice communication without the need for authentication, disclosed in the present disclosure, the network voice communication further comprises: the user sets a no-disturb time to refuse to receive a network call within a no-disturb period of time.

In the method for network voice communication without the need for authentication, disclosed in the present disclosure, when the user sets a no-disturb time, the user can set his or her own phone greeting to remind the opposite party of the inconvenience of answering the network call and hope to leave a message.

In the method for network voice communication without the need for authentication, disclosed in the present disclosure, the network voice communication further comprises sending and receiving a voice e-mail.

In the method for network voice communication without the need for authentication, disclosed in the present disclosure, the sending and receiving voice e-mail comprises: controlling the sending of the voice e-mail to be delayed. The controlling the sending of the voice e-mail to be delayed comprises: a sending terminal records voice to generate to-be-sent voice e-mail; the sending terminal sets the time controlling the voice e-mail to send after delay and confirms the sending of the voice e-mail; setting a time clock with respect to the sending of the voice e-mail and counting; the sending terminal sends the voice e-mail after the predetermined time arrives; a receiving terminal receives the voice e-mail.

The disclosure has the following advantages.

The method for network voice communication provided by the present disclosure utilizes the sharing property of the Internet to extend the scope of free call applications to support mobile phones, tablets and IP landline phones (Internet phones), and even proposes a new concept of the network mobile phone, which may access the Internet, has not telecommunications signal reception function, and realizes a free call function. In addition, the disclosure can realize the function of a searchable global phonebook, i.e. yellow pages, and provide the convenience for users and businesses to inquire and promote products and services, that is, saves money and manpower.

### BRIEF DESCRIPTION OF THE DRAWINGS

FIG. 1 is a schematic flow chart of a method for network voice communication in the present disclosure.

FIG. 2 is a schematic flow chart of controlling voice e-mail to be sent successfully after delay during sending and receiving a voice e-mail in the present disclosure.

### DETAILED DESCRIPTION

The following embodiments illustrate the present disclosure, but are not intended to limit the scope of the present disclosure.

### Embodiment 1

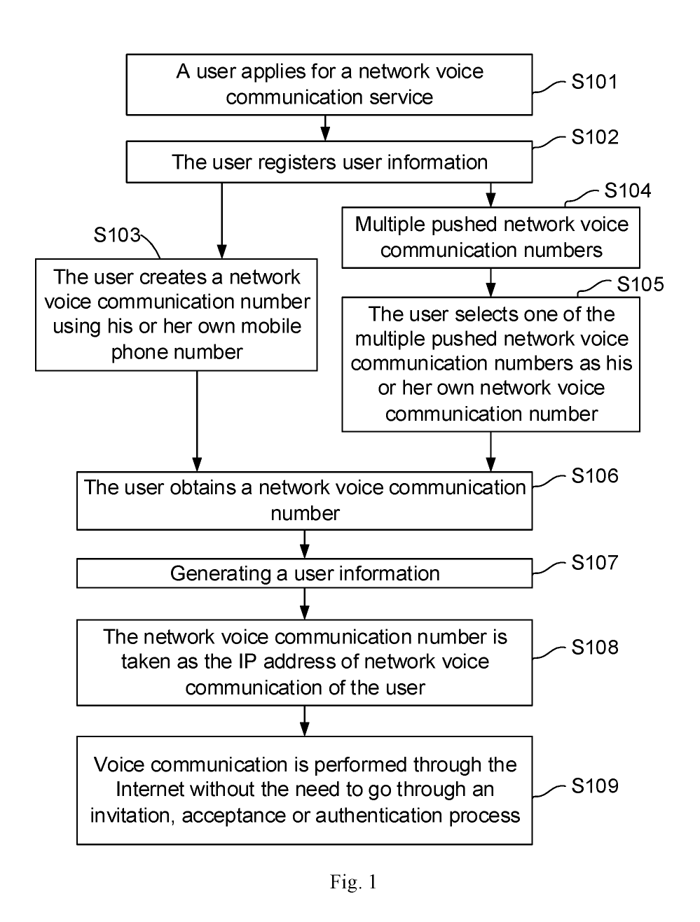

With reference to FIG. 1, the present disclosure provides a method for network voice communication, comprising:

S101: A user in the global world applies a network voice communication service system for a network voice communication service through a network voice communication client;

S102: The user registers user information;

S103: The user creates a network voice communication number using his or her own mobile phone number, the network voice communication number consists of three fixed digits, a country code and a mobile phone number, therein the three fixed digits being 881;

Or S104: The system pushes multiple network voice communication numbers;

S105: The user selects one number from the multiple pushed network voice communication numbers as his or her own network voice communication number, wherein the network voice communication number consists of three fixed digits and ten arbitrary digits arranged in sequence, and therein the three fixed digits are 882.

S106: The user obtains a network voice communication number, wherein the network voice communication number completely consists of multiple digits;

S107: User information is generated, comprising a name, a network voice communication number and an e-mail, the three of which are necessary to the user. In addition, the user information further comprises one or more of mobile phone number, country, network link, website address, profession and personal description. The personal description may consist of one or more keywords. The user may choose to fill in this information, and the generated user information forms a phonebook and is displayed on a user terminal, so that through Wi-Fi and the Internet, a free global phonebook service can be achieved. The user queries a keyword or keywords from the phonebook at the user terminal, and business and personal information of the user information may be searched for worldwide. The unique global phonebook search integrates users registered anywhere in the global world and may help businesses and individuals be confirmed and contacted through here;

S108: The network voice communication number is taken as the network address of network voice communication of the user.

S109: Voice communication is performed between users that have obtained network voice communication number through the Internet. During network voice communication, users do not need to go through an invitation, acceptance or authentication process with each other, that is, with respect to a number on the contact list of a phonebook, there is no need for invitation, acceptance or authentication, and it is enough to log in a network voice communication client and then directly dial the network voice communication number, whist there are no international roaming charges.

In the foregoing description, one of the purposes for which a company user registers for a network voice communication number may be to enable more people to search themselves from a global phonebook. During registration, in addition to their own company's contact person, contact information, website address and profile to be filled, the keyword is a very important element. During the registration of user information, after the first page of detailed information has been filled in and submitted, the second page follows for network address, link, industry, keyword(s) and profile, all of which are optional. However, the complete information indicates the higher probability of being searched, especially in a situation where a keyword is set. Keyword can be extracted from the company name, for example, for a timber company, timber can be chosen as the keyword, considering customers' needs. The company's product name or the industry to which the company belongs can also be chosen as the keyword. The best approach is that all of these three kinds of keywords are successfully set, as the more keywords set, the greater the probability of being searched.

In the method for network voice communication without the need for authentication, disclosed in the present disclosure, an invitation, acceptance or authentication process is no longer needed, and no further payment (free of monthly fee and charges for local and long distance calls concerning the telephone number) is required. With the sharing property of the Internet, applicable user terminals may comprise mobile phones, computers, tablets, IP landline phones (Internet phones), Internet mobile phones (that may access the Internet and have no telecommunications signal reception function).

In the method for network voice communication without the need for authentication, disclosed in the present disclosure, the network voice communication further comprises: the user sets a no-disturb time to refuse to receive a network call within a no-disturb period of time. When the user sets a no-disturb time, the user may further set his or her own phone greeting to remind the opposite party of the inconvenience of answering the network call and hope to leave a message.

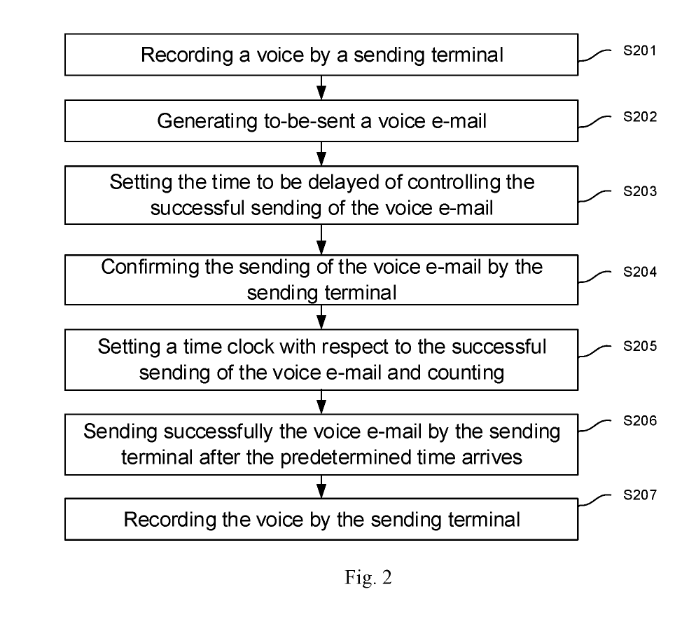

In the method for network voice communication without the need for authentication, disclosed in the present disclosure, the network voice communication further comprises sending and receiving a voice e-mail. The sending and receiving a voice e-mail comprises: controlling the sending of the voice e-mail to be delayed. With reference to FIG. 2, the controlling the sending of the voice e-mail to be delayed comprises:

S201: recording a voice by a sending terminal;

S202: generating to-be-sent a voice e-mail;

S203: setting the time controlling the voice e-mail send after delay by the sending terminal;

S204: confirming the sending of the voice e-mail by the sending terminal;

S205: setting a time clock with respect to the sending of the voice e-mail and counting;

S206: sending the voice e-mail by the sending terminal after the predetermined time arrives;

S207: receiving the voice e-mail by the receiving terminal.

The described method of controlling the sending of the voice e-mail to be delayed during the sending and receiving a voice e-mail allows for voice e-mail to be delayed, rather than to be sent immediately after the sending of the voice e-mail has been confirmed at the sending terminal, but on the contrary, to be sent after the predetermined time arrives. In this way, when the sending terminal is about to send voice e-mail while the receiving terminal is in a rest state or in a meeting stage and is not convenient for receiving the voice e-mail, the sending terminal is required to send the voice e-mail later. In addition, if the voice e-mail sender is worried about forgetting to send the voice e-mail afterwards, the described method of controlling the sending of the voice e-mail to be delayed may be used to solve that problem.

Although the disclosure has been described in detail in the foregoing by way of a generic description and specific embodiments, it will be apparent to those skilled in the art that certain modifications or improvements may be made thereto based on the disclosure. Therefore, these modifications or improvements made without departing from the spirit of the present disclosure all fall within the protection scope of the present disclosure.

What is claimed is:

1. A method for network voice communication, comprises:
applying for and obtaining a network voice communication number through a network voice communication client by users in the global world, the network voice communication number entirely consists of the multiple digits;
using the network voice communication number as the network address of network voice communication of the users;
performing voice communication between the users that have obtained the network voice communication numbers through the Internet;
wherein there is no need for the users to go through an invitation, acceptance or authentication process during the network voice communication.

2. The method for network voice communication according to claim 1, wherein applying for and obtaining a network voice communication number by users in the global world comprises: after the user has applied, using his or her own mobile phone number to create a network voice communication number, wherein the network voice communication number consists of three fixed digits, a country code and a mobile phone number arranged in sequence, and wherein the three fixed digits are 881.

3. The method for network voice communication according to claim 1, wherein the user applying for and obtaining a network voice communication number comprises: after the user has applied, selecting one number from the multiple pushed network voice communication numbers as his or her own network voice communication number, wherein the network voice communication number consists of three fixed digits and ten arbitrary digits arranged in sequence, and wherein the three fixed digits are 882.

4. The method for network voice communication according to claim 1, wherein the user applying for and obtaining a network voice communication number further comprises: the user registers to generate a user information, the user information comprises a name, a network voice communication number and an e-mail, and the generated user information form a phonebook and present on a user terminal, and the user can query from the phonebook by a keyword or a plurality of keywords on the user terminal.

5. The method for network voice communication according to claim 4, wherein the user information further comprises one or more of mobile phone number, country, network link, website address, profession and personal description.

6. The method for network voice communication according to claim 5, wherein the personal description consists of one or more keywords.

7. The method for network voice communication according to claim 1, further comprises: setting, by the user, a no-disturb time to refuse to receive a network call within a no-disturb period of time.

8. The method for network voice communication according to claim 7, wherein when the user sets a no-disturb time, the user can set his or her own phone greeting to remind the opposite party of the inconvenience of answering the network call and hope to leave a message.

9. The method for network voice communication according to claim 8, further comprises sending and receiving a voice e-mail.

10. The method for network voice communication according to claim 9, wherein sending and receiving voice e-mail comprises: controlling the sending of the voice e-mail to be delayed, and the controlling the sending of the voice e-mail to be delayed comprises:
recording a voice, by a sending terminal, to generate to-be-sent voice e-mail;
setting the time controlling the voice e-mail to send after delay and confirms the sending of the voice e-mail by the sending terminal;
setting a time clock with respect to the sending of the voice e-mail and counting;
sending the voice e-mail after the predetermined time arrives by the sending terminal;
receiving the voice e-mail by a receiving terminal.
